(19) United States
(12) Patent Application Publication
(10) Pub. No.: US 2021/0130645 A1
(43) Pub. Date: May 6, 2021

(54) COMPOUND, WATER-BORNE EPOXY RESIN COMPOSITION COMPRISING THE SAME, AND COATING COMPOSITION COMPRISING THE WATER-BORNE EPOXY RESIN COMPOSITION

(71) Applicant: CHANG CHUN PLASTICS CO., LTD., Taipei (TW)

(72) Inventors: YING-JUI LIN, Taipei (TW); LIANG-HSING LIU, Taipei (TW); YUNG-SHENG LIN, Taipei (TW); KUO-PIN WU, Taipei (TW); I-CHIANG LAI, Taipei (TW); YI-SERN WONG, Taipei (TW); KUEN-YUAN HWANG, Taipei (TW)

(21) Appl. No.: 16/749,132

(22) Filed: Jan. 22, 2020

(30) Foreign Application Priority Data
Nov. 4, 2019 (TW) 108139953

(51) Int. Cl. C09D 163/00; C08G 65/08; C08G 81/00; C08L 63/00

(52) U.S. Cl. CPC C09D 163/00; C08L 63/00; C08G 81/00; C08G 65/08

(57) ABSTRACT

The present invention provides a compound comprising EO (ethylene oxide)/PO (propylene oxide) block copolymer which can be used as an emulsifier. The present invention also provides a water-borne epoxy resin composition comprising the compound and a coating composition comprising the water-borne epoxy resin composition. The advantages of the present invention is that the epoxy resin composition or the coating composition, which the compound of the present invention is added to, enhances the compatibility between water and epoxy resin, and enhances the anticorrosive properties of the epoxy resin composition and the coating composition.

### BACKGROUND OF THE INVENTION

### 1. Technical Field

The present invention relates to a compound, a water-borne epoxy resin composition containing the compound, and a coating composition containing the water-borne epoxy resin composition. More particularly, the invention relates to a compound containing an ethylene oxide (EO)/propylene oxide (PO) block copolymer, a water-borne epoxy resin composition containing the compound, and a coating composition containing the water-borne epoxy resin composition.

### 2. Description of Related Art

Epoxy resin compositions are used extensively in coating materials, adhesives, laminates, and so on due to the outstanding mechanical and adhesion properties of their end products, and have given rise to a market that is expected to grow at a steady pace. The production of an epoxy resin composition typically involves diluting an epoxy resin with an organic solvent, which, however, tends to cause environmental hazards and is therefore undesirable given the rising awareness of environmental protection.

In light of the above, water-borne epoxy resins, which are soluble in water, have been developed to reduce pollution associated with the use of volatile organic solvents. Such environmental friendliness has attached great importance to water-borne epoxy resins and promises continual growth of the global water-borne epoxy resin market. The existing water-borne epoxy resins, however, are still flawed in terms of water resistance, mechanical stability, corrosion resistance, and adhesion to the substrates they are applied to. A new product needs to be developed to address the aforesaid issues.

One conventional method for making a water-borne epoxy resin entails stirring a surfactant with the other ingredients at high speed in a homogenizer, and yet the resulting epoxy resin emulsion is disadvantaged by low water resistance, low adhesion to substrates or surface coats, and low mechanical stability. Water-borne epoxy resins that contain no surfactant also exist in the prior art, but difficulties in increasing the cross-linking density of the cured products (e.g., coatings) of their epoxy resin compositions lead to low mechanical strength and low corrosion resistance of such coatings.

### BRIEF SUMMARY OF THE INVENTION

As above, to solve these problems, the present invention provides a compound of chemical formula (I):

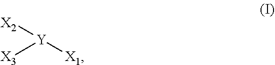

wherein Y represents an alicyclic or aromatic group; X₁ represents

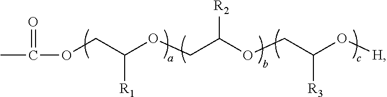

in which at least one or at most two of R₁, R₂, and R₃ are C₁˜C₄ alkyl groups while the remaining ones or one of R₁, R₂, and R₃ is H; at least one of X₂ and X₃ is —COOH or

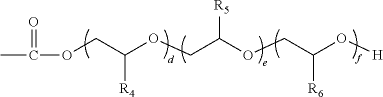

while the remaining one, if any, of X₂ and X₃ is H, wherein each of R₄, R₅, and R₆ is H or a C₁˜C₄ alkyl group; and each of a, b, c, d, e, and f represents the number of a repeating unit marked thereby and is an integer ranging from 1 to 150.

In a preferred embodiment, the compound has a structure of at least one selected from the group consisting of chemical formulas (II)˜(VII):

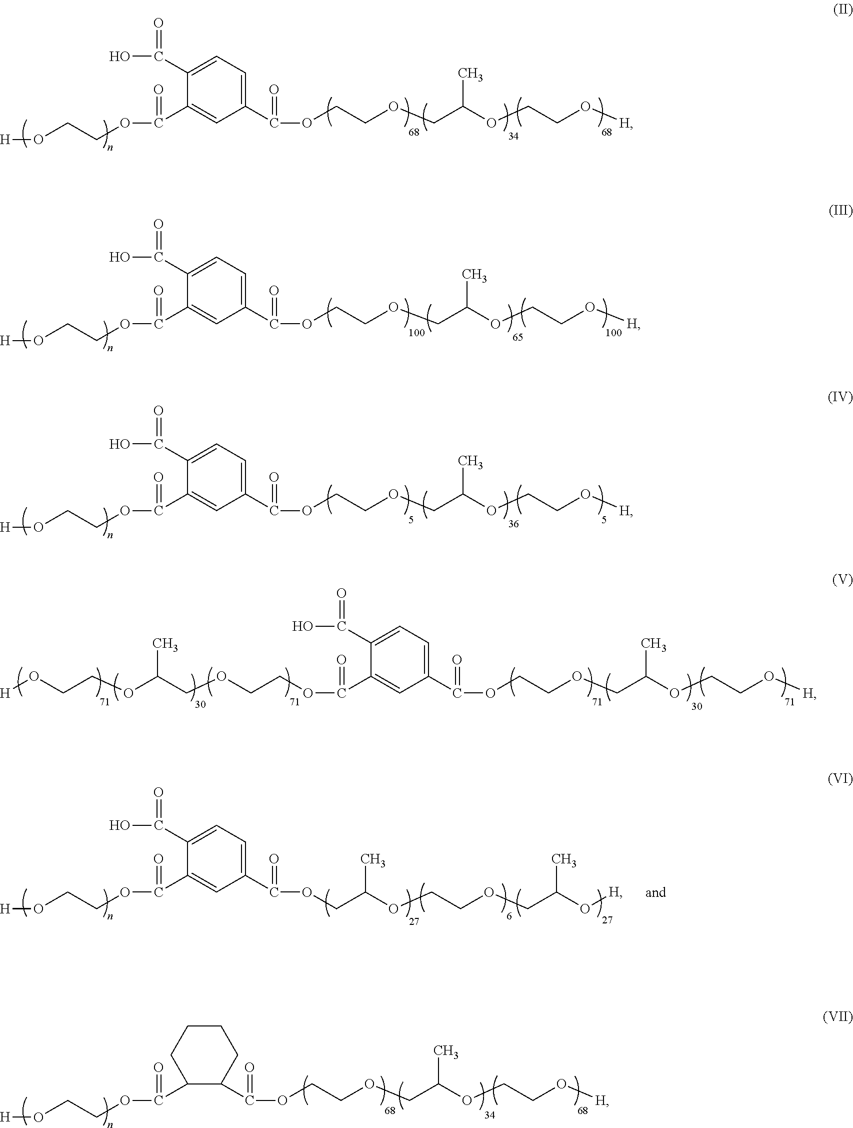

where each n independently represents the number of the repeating units marked thereby and is an integer ranging from 5 to 250.

In a preferred embodiment, Y is at least one selected from the group consisting of phthalic acid anhydride, trimellitic acid anhydride, pyromellitic acid anhydride, benzophenone-tetracarboxylic acid anhydride, ethylene glycol bis-trimellitate acid anhydride, glycerol tris-mellitate, maleic anhydride, tetrahydrophthalic acid anhydride, methyltetrahydrophthalic acid anhydride, endomethylenetetrahydrophthalic acid anhydride, methylendometylenetetrahydrophthalic acid anhydride, methylbutenyltetrahydrophthalic acid anhydride, dodecenylsuccinic acid anhydride, hexahydrophthalic acid anhydride, methylhexahydrophthalic acid anhydride, succinic acid anhydride, methylcyclohexene-dicarboxylic acid anhydride, alkylstyrene-maleic anhydride copolymers, chlorendic acid anhydride, tetrabromophthalic acid anhydride, polyazelaic acid anhydride, fumaric acid anhydride, itaconic acid anhydride, acrylic acid anhydride, and methacrylic acid anhydride.

Another objective of the present invention is to provide a water-borne epoxy resin composition comprising: (a) an epoxy resin; and (b) the compound as described above.

In a preferred embodiment, the (b)/(a) ratio ranges from 5% to 15%.

In a preferred embodiment, the epoxide equivalent of the epoxy resin is 150˜3500.

In a preferred embodiment, the epoxide equivalent of the epoxy resin is 150˜650.

In a preferred embodiment, the epoxide equivalent of the epoxy resin is 500˜650.

Still another objective of the present invention is to provide a coating composition comprising the water-borne epoxy resin composition as described above dispersed in a solvent.

In a preferred embodiment, the coating composition further includes an additive, which is selected from the group consisting of a pigment, a dye, an anti-foaming agent, an anti-flash rust agent, a rheology modifier, a filler, an extender, a corrosion inhibitor, a dispersing agent, and a combination of the above.

In a preferred embodiment, the coating composition further includes a curing agent.

In a preferred embodiment, the coating composition has a solid content ranging from 50% to 60%.

In a preferred embodiment, the coating composition has a viscosity ranging from about 130 cps/25° C. to about 18000 cps/25° C.

In a preferred embodiment, the coating composition has a viscosity ranging from about 4000 cps/25° C. to about 17000 cps/25° C.

In a preferred embodiment, the coating composition has a viscosity higher than 600 cps/25° C.

In a preferred embodiment, the coating composition has grade B or higher hardness when tested according to ASTM D3363-00 Standard Test Method for Film Hardness by Pencil Test.

In a preferred embodiment, the coating composition has grade 5B adhesion when tested according to ASTM D3359-09 Standard Test Methods for Measuring Adhesion by Tape Test.

In a preferred embodiment, the coating composition has a loss of mass less than about 0.36 g in the salt spray test (ASTM B117).

In a preferred embodiment, the coating composition has a loss of mass less than about 0.20 g in the salt spray test (ASTM B117).

In a preferred embodiment, the coating composition has a loss of mass less than about 0.17 g in the salt spray test (ASTM B117).

Therefore, one objective of the present invention is to provide a novel compound that functions as a surfactant and can be added to an epoxy resin composition as an emulsifier to enhance the compatibility of the epoxy resin in the composition with water and thereby increase the water solubility of the epoxy resin composition containing the compound. The invention further provides a water-borne epoxy resin composition that uses water as its solvent, and a coating composition containing the water-borne epoxy resin composition, wherein both compositions have a much lower volatile organic compound (VOC) content than their prior art counterparts. A coating made of the water-borne epoxy resin composition has not only a low VOC content, but also improved surface properties such as high hardness, high adhesion, and high resistance to corrosion. Furthermore, the molecular weight of the compound disclosed herein for use as an emulsifier in the water-borne epoxy resin composition and the coating composition may vary in order to adjust the viscosity of those compositions and thereby meet the requirements of their respective applications.

Other features and advantages of the invention will be apparent from the Detailed Description, and from the claims. Thus, other aspects of the invention are described in the following disclosure and are within the ambit of the invention. The intermediate compounds also form part of the disclosed invention.

### BRIEF DESCRIPTION OF THE SEVERAL VIEWS OF THE DRAWINGS

Non-limiting embodiments will be described below in conjunction with the drawings. It is to be understood that the following drawings are merely illustrative of the embodiments of the invention, but not restrictive of the scope of the present invention. The exemplary embodiments and examples disclosed herein are described by way of illustration, where:

FIG. 1 is a flow chart of embodiment 1 of the present invention, showing the steps for synthesizing the compound S1.1 and the water-borne epoxy resin composition S1.2.

FIG. 2 is a flow chart of embodiment 2 of the present invention, showing the steps for synthesizing the compound S2.1 and the water-borne epoxy resin composition S2.2.

FIG. 3 is a flow chart of embodiment 3 of the present invention, showing the steps for synthesizing the compound S3.1 and the water-borne epoxy resin composition S3.2.

FIG. 4 is a flow chart of embodiment 4 of the present invention, showing the steps for synthesizing the compound S4.1 and the water-borne epoxy resin composition S4.2.

FIG. 5 is a flow chart of embodiment 5 of the present invention, showing the steps for synthesizing the compound S5.1 and the water-borne epoxy resin composition S5.2.

FIG. 6 is a flow chart of embodiment 6 of the present invention, showing the steps for synthesizing the compound S6.1 and the water-borne epoxy resin composition S6.2.

FIG. 7 is a flow chart of the comparison example of the present invention, showing the steps for synthesizing the compound C1.1 and the water-borne epoxy resin composition C1.2.

FIG. 8 is a photograph of the samples of application embodiments 1 to 6 and the comparison example subjected to a corrosion test (test 2).

### DETAILED DESCRIPTION OF THE INVENTION

Throughout the whole document, the terms “comprise or include” and/or “comprising or including” used in the document mean that one or more other components, steps, operations, and/or the existence or addition of elements are not excluded in addition to the described components, steps, operations and/or elements. The terms “about” or close to” or “substantially” or “approximately” mean a value or range that is close to the allowable specified error to avoid any unreasonable use by third parties, illegal or unfair use, to understand the precise or absolute value disclosed herein. The terms “a” and “an” refer to one or to more than one (i.e., to at least one) of the grammatical object of the article.

The present invention provides a compound of chemical formula (I):

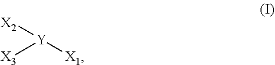

wherein Y represents an alicyclic or aromatic group; X₁ represents

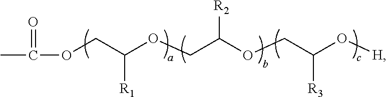

in which at least one or at most two of R₁, R₂, and R₃ are C₁˜C₄ alkyl groups while the remaining ones or one of R₁, R₂, and R₃ is H; at least one of X₂ and X₃ is —COOH or

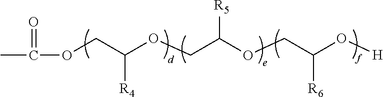

while the remaining one, if any, of X₂ and X₃ is H, wherein each of R₄, R₅, and R₆ is H or a C₁˜C₄ alkyl group; and each of a, b, c, d, e, and f represents the number of a repeating unit marked thereby and is an integer ranging from 1 to 150. The present invention also provides a water-borne epoxy resin composition comprising: (a) an epoxy resin; and (b) the compound as described above. In addition, the present invention provides a coating composition comprising the water-borne epoxy resin composition as described above dispersed in a solvent.

More specifically, Y in formula (I) may be an acid anhydride. Each acid anhydride molecule has two, three, four, or six functional groups. The acid anhydride having two functional groups is, for example but not limited to, at least one selected from the group consisting of phthalic acid anhydride, glycerol tris-mellitate, maleic anhydride, tetrahydrophthalic acid anhydride, methyltetrahydrophthalic acid anhydride, endomethylenetetrahydrophthalic acid anhydride, methylendometylenetetrahydrophthalic acid anhydride, methylbutenyltetrahydrophthalic acid anhydride, dodecenylsuccinic acid anhydride, hexahydrophthalic acid anhydride, methylhexahydrophthalic acid anhydride, succinic acid anhydride, methylcyclohexene-dicarboxylic acid anhydride, chlorendic acid anhydride, tetrabromophthalic acid anhydride, polyazelaic acid anhydride, fumaric acid anhydride, itaconic acid anhydride, acrylic acid anhydride, and methacrylic acid anhydride. The acid anhydride having three functional groups is, for example but not limited to, trimellitic acid anhydride. The acid anhydride having four functional groups is, for example but not limited to, at least one selected from the group consisting of pyromellitic acid anhydride, benzophenone-tetracarboxylic acid anhydride, and ethylene glycol bis-trimellitate acid anhydride. The acid anhydride having six functional groups is, for example but not limited to, alkylstyrene-maleic anhydride copolymers.

One important feature of the compound of the present invention is that the compound contains an ethylene oxide (EO)/propylene oxide (PO) block copolymer, in which the EO chain segment is hydrophilic and therefore helps enhance the compatibility of the compound with water, whereas the PO chain segment is lipophilic and therefore helps enhance the compatibility of the compound with an epoxy resin. In one preferred embodiment, the compound is formed by the reaction between an acid anhydride (e.g., trimellitic anhydride (TMA) or hexahydrophthalic anhydride (HHPA)) and an “EO/PO block copolymer-containing compound”. The “EO/PO block copolymer-containing compound” may be, for example but not limited to, an EO-PO-EO block copolymer-containing compound or a PO-EO-PO block copolymer-containing compound. The EO/PO block copolymer-containing compound has a molecular weight of, for example but not limited to, 2500˜20000, preferably 3500˜15000, and more preferably 8000˜12500. The molecular weight of the EO/PO block copolymer-containing compound may be chosen as appropriate to the intended application of the compound of the invention, in order to achieve the desired viscosity of the end product of the compound of the invention. In another preferred embodiment, the compound of the invention is formed by the reaction between an acid anhydride (e.g., TMA or HHPA), an EO/PO block copolymer-containing compound, and a polyethylene glycol (which has an EO chain segment), wherein the polyethylene glycol may have a molecular weight of 1000˜10000, preferably 3000˜8000.

The aforesaid EO-PO-EO block copolymer-containing compound may be represented by, for example, the following chemical formula (VIII), in which x=68, y=34, and z=68 (i.e., x:y:z=2:1:2), as in the case of Genapol PF 80 (whose molecular weight (MW)=8000 and which is commercially available from Clariant); x=5, y=36, and z=5 (i.e., x:y:z=0.14:1:0.14), as in the case of Genapol PF 20 (whose MW=2500 and which is commercially available from Clariant); x=100, y=65, and z=100 (i.e., x:y:z=1.5:1:1.5), as in the case of Pluronic F127 (whose MW=12500 and which is commercially available from BASF); or x=71, y=30, and z=71 (i.e., x:y:z=2.4:1:2.4), as in the case of Pluronic PE 6800 (whose MW=8000 and which is commercially available from BASF).

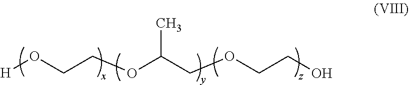

The aforesaid PO-EO-PO block copolymer-containing compound may be represented by, for example, the following chemical formula (IX), in which x=27, y=6, and z=27 (i.e., x:y:z=1:0.22:1), as in the case of Pluronic RPE 3110 (whose MW=3500 and which is commercially available from BASF).

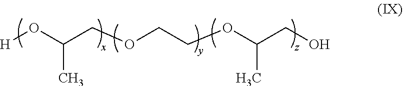

The aforesaid polyethylene glycol may be represented by, for example, the following chemical formula (X), in which n=22, as in the case of polyglykol 1000 (whose MW=1000 and which is commercially available from Clariant); or n=180, as in the case of polyglykol 8000 (whose MW=8000 and which is commercially available from Clariant).

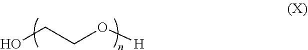

The compound represented by the general formula (I) may have at least one of the structures represented respectively by the following chemical formulas (II)˜(VII):

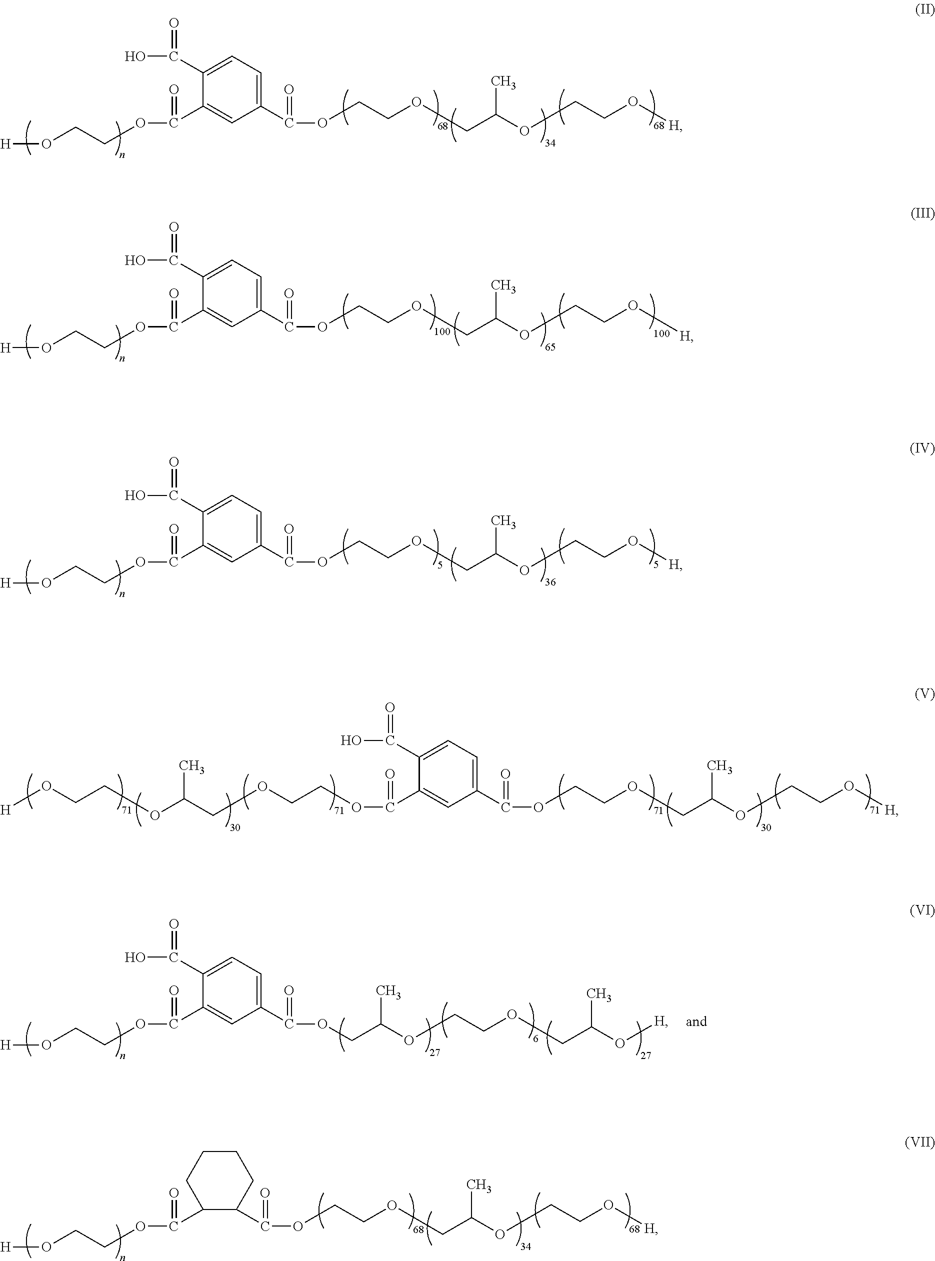

where each n independently represents the number of the repeating units marked thereby and is an integer ranging from 5 to 250.

One application of the compound of the present invention is to be used as a surfactant, or more particularly as an emulsifier added to an epoxy resin to form an epoxy resin composition (especially a water-borne epoxy resin composition). As the EO chain segment of the compound of the invention is hydrophilic and contributes to enhancing the compatibility of the compound with water, an epoxy resin composition containing the compound is highly soluble in water. Moreover, as the PO chain segment of the compound of the invention is lipophilic and contributes to enhancing the compatibility of the compound with epoxy resin, an epoxy resin composition containing the compound is highly resistant to corrosion.

A water-borne epoxy resin composition formulated according to the present invention is a resin composition that can be prepared in water or in a mixture of water and a water-soluble solvent and may take the form of, for example but not limited to, a suspension, an emulsion, or a microemulsion. The epoxy resin in such a water-borne epoxy resin composition may be any known epoxy resin, such as but not limited to a bisphenol A (BPA)-based epoxy resin (e.g., an epoxy resin made from epichlorohydrin (or β-methyl epichlorohydrin) and BPA (or bisphenol F or bisphenol S)), a polyglycidyl ether of a polyol (e.g., a phenol-formaldehyde polyglycidyl ether resin or a cresol-formaldehyde polyglycidyl ether resin), a polyglycidyl ether of an alkylene oxide adduct (e.g., BPA, polypropylene glycol, 1,6-hexanediol, trimethylolpropane, or glycerol), a polyglycidyl ether of a polybasic carboxylic acid (e.g., adipic acid, phthalic acid, or a dimer acid), or a polyglycidyl amine.

As used herein, the term “epoxide equivalent” refers to the weight (in grams) of an epoxy resin that contains 1 mole equivalent of epoxide. The epoxide equivalent can be measured or monitored by any method known in the art, such as by pyrolysis-gas chromatography, gel permeation chromatography, spectral analysis (e.g., infrared, near-infrared, or nuclear magnetic resonance spectroscopy), or titration. The aforesaid epoxy resin has an epoxide equivalent falling within a proper range: if the epoxide equivalent is too high, the softening point of the epoxy resin will be so high that a coating material containing the epoxy resin will have poor film forming properties and must be added with more solvent to improve such properties; conversely, if the epoxide equivalent is too low, the epoxy resin will have high cross-linking density when cured that the coating formed by a coating material containing the epoxy resin will have low flexibility and low resistance to impact because of its high hardness. In one preferred embodiment, the epoxide equivalent of the epoxy resin used is 150˜3500, such as, but not limited to, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450 or 3500. In a more preferred embodiment, the epoxide equivalent of the epoxy resin used is 150˜650, such as, but not limited to, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640 or 650. In another more preferred embodiment, the epoxide equivalent of the epoxy resin used is 500˜650, such as, but not limited to, 500, 502, 504, 506, 508, 510, 512, 514, 516, 518, 520, 522, 524, 526, 528, 530, 532, 534, 536, 538, 540, 542, 544, 546, 548, 550, 552, 554, 556, 558, 560, 562, 564, 566, 568, 570, 572, 574, 576, 578, 580, 582, 584, 586, 588, 590, 592, 594, 596, 598, 600, 602, 604, 606, 608, 610, 612, 614, 616, 618, 620, 622, 624, 626, 628, 630, 632, 634, 636, 638, 640, 642, 644, 646, 648 or 650.

A water-borne epoxy resin composition formulated according to the present invention contains the compound of the invention and an epoxy resin at a ratio (i.e., the (b)/(a) ratio) ranging from 5% to 15%, such as, but not limited to, 5% to 15%, 5% to 14%, 5% to 13%, 5% to 12%, 5% to 11%, 5% to 10%, 5% to 9%, 5% to 8%, 5% to 7%, 5% to 6%, 6% to 15%, 6% to 14%, 6% to 13%, 6% to 12%, 6% to 11%, 6% to 10%, 6% to 9%, 6% to 8%, 6% to 7%, 7% to 15%, 7% to 14%, 7% to 13%, 7% to 12%, 7% to 11%, 7% to 10%, 7% to 9%, 7% to 8%, 8% to 15%, 8% to 14%, 8% to 13%, 8% to 12%, 8% to 11%, 8% to 10%, 8% to 9%, 9% to 15%, 9% to 14%, 9% to 13%, 9% to 12%, 9% to 11%, 9% to 10%, 10% to 15%, 10% to 14%, 10% to 13%, 10% to 12%, 10% to 11%, 11% to 15%, 11% to 14%, 11% to 13%, 11% to 12%, 12% to 15%, 12% to 14%, 12% to 13%, 13% to 15%, 13% to 14% or 14% to 15%.

A coating composition formulated according to the present invention can be prepared by dispersing the foregoing water-borne epoxy resin composition in a solvent, wherein the solvent is preferably water or a mixture of water and a water-soluble solvent. In one preferred embodiment, the coating composition further includes an additive, which can be selected from the group consisting of a pigment, a dye, an anti-foaming agent, an anti-flash rust agent, a rheology modifier, a filler, an extender, a corrosion inhibitor, a dispersing agent, and a combination of the above. In another preferred embodiment, the coating composition further includes a curing agent. In other words, a water-borne epoxy resin composition formulated according to the invention can be mixed with an additive (e.g., a dye, a coloring agent, and/or an anti-foaming agent) and a curing agent to produce the coating composition of the invention, which can be applied to a substrate to form a coating.

As used herein, the terms “pigment” and “dye” refer to any substance that provides wavelength selectivity and can therefore change the color of the light reflected by or passing through a material containing the substance. Dyes are soluble chemicals, and pigments are generally solid particles. Pigments and dyes can be classified as organic or inorganic. In some embodiments, the pigment(s) used to prepare the water-borne epoxy resin coating composition of the invention is/are one or more selected from the group consisting of ultramarine violet (e.g., a sulfur-containing sodium silicate or aluminosilicate), Han purple (i.e., BaCuSi₂O₆), a cobalt-based pigment (e.g., cobalt violet, i.e., cobalt orthophosphate), a manganese-based pigment (e.g., manganese violet (NH₄MnP₂O₇)), a gold-based pigment (e.g., purple of Cassius, i.e., nanoparticles of gold suspended in tin oxide, ultramarine-PB29), a sulfur-containing sodium silicate(Na₈₋₁₀Al₆Si₆O₂₄S₂₋₄), Persian blue (i.e., ground lapis lazuli), cobalt blue-PB28, cerulean blue-PB35, Egyptian blue (a calcium copper silicate, namely CaCuSi₄O₁₀), Han blue (i.e., BaCuSi₄O₁₀), azurite (i.e., copper carbonate hydroxide (Cu₃(CO₃)₂(OH)₂)), Prussian blue-PB27 (i.e., ferric hexacyanoferrate (Fe₇(CN)₁₈)), YInMn blue, manganese blue (e.g., barium manganate(VI) sulfate), cadmium green, chrome green-PG17, chromic oxide (Cr₂O₃), viridian-PG18 (Cr₂O₃.H₂O), cobalt green (CoZnO₂), malachite (Cu₂CO(OH)₂), Scheele's green (i.e., cupric arsenite (CuHAsO₃)), green earth/terre verte/verona green (K[(Al,Fe^{III}),(Fe^{II},Mg)](AlSi₃,Si₄)O₁₀(OH)₂), orpiment (i.e., As₂S₃), primrose yellow-PY184 (i.e., bismuth vanadate (BiVO₄)), cadmium yellow-PY37 (e.g., CdS), chrome yellow-PY34 (i.e., CrO₄), aureolin or cobalt yellow-PY40 (i.e., K₃Co(NO₂)₆), yellow ochre-PY43 (i.e., Fe₂O₃.H₂O), Naples yellow-PY41, lead/tin yellow (e.g., PbSnO₄ or Pb(Sn,Si)O₃), titanium yellow-PY53, mosaic gold (i.e., SnS₂), zinc yellow-PY36 (i.e., ZnCrO₄), cadmium orange-PO20 (i.e., cadmium sulfoselenide), chrome orange (i.e., PbCrO₄+PbO), realgar (i.e., As₄S₄), cadmium red-PR108 (i.e., Cd₂SSe), sanguine, caput mortuum, Indian red, Venetian red, oxide red-PR102, red ochre-PR102 (i.e., anhydrous Fe₂O₃), burnt sienna-PBr7, minium pigment (i.e., Pb₃O₄), vermilion-PR106 (i.e., cinnabar), mercuric sulfide (HgS), a clay-based pigment (e.g., an iron oxide), raw umber-PBr7 (i.e., Fe₂O₃+MnO₂+nH₂O+Si+Al₂O₃, which is referred to as burnt umber when calcinated (heated), with burnt umber having a more intense color than raw umber), raw sienna-PBr7 (i.e., limonite clay), carbon black-PBk7, ivory black-PBk9, vine black-PBk8, lamp black-PBk6, an iron-based pigment, Mars black-PBk1 (i.e., Fe₃O₄), manganese dioxide (MnO₂), titanium black (i.e., Ti₂O₃), antimony white (i.e., Sb₂O₃), barium sulfate-PW5 (i.e., BaSO₄), lithopone (i.e., BaSO₄.ZnS), cremnitz white-PW1 (i.e., (PbCO₃)₂—Pb(OH)₂), titanium white-PW6 (i.e., TiO₂), zinc whilte-PW4 (i.e., ZnO), 1,2-dihydroxyanthraquinone, anthoxanthin, arylide yellow, an azo dye, a bilin (e.g., bilirubin), soot, bone char, carmine (i.e., an aluminum salt of carminic acid), a diarylide-based pigment, dibromoanthanthrone, dragon's blood, gamboge, Indian yellow (e.g., magnesium euxanthate or calcium euxanthate), an indigo dye (e.g., 2,2′-bis(2,3-dihydro-3-oxoindolyliden or indigotin), naphthol AS (i.e., 3-hydroxy-N-phenylnaphthalene-2-carboxamide), naphthol red (i.e., 4-(2-(4-carbamoylphenyl)hydrazono)-N-(2-ethoxyphenyl)-3-oxo-3,4-dihydronaphthalene-2-carboxamide), ommochrome (i.e., a metabolite of tryptophan, generated via kynurenine and 3-hydroxy-kynurenine), perinone, Phthalocyanine Blue BN, Phthalocyanine Green G, Pigment Purple 23, Pigment Yellow 10, Pigment Yellow 12, Pigment Yellow 13, Pigment Yellow 16, Pigment Yellow 81, Pigment Yellow 83, Pigment Yellow 139, Pigment Yellow 185, quinacridone, rose madder (e.g., alizarin or purpurin), a rylene dye, and tyrian purple (i.e., 6,6′-dibromoindigo). In some embodiments, the pigment used is titanium dioxide (TiO₂).

As used herein, the term “defoamer” or “anti-foaming agent” refers to a chemical additive for reducing and hindering the formation of foam. Such an additive may have a single-compound or multiple-compound formula. Anti-foaming agents include FOAMASTER® and FOAMSTAR® of BASF, such as FOAMASTER® MO 2134, FOAMASTER® MO 2150, FOAMASTER® NO 2335, FOAMSTAR ED 2521, FOAMSTAR ED 2522, FOAMSTAR ED 2523, FOAMSTAR NO 2306, FOAMSTAR SI 2210, FOAMSTAR SI 2213, FOAMSTAR SI 2216, FOAMSTAR SI 2250, FOAMSTAR SI 2280, FOAMSTAR ST 2293, FOAMSTAR ST 2438 or FOAMSTAR ST 2454. In some embodiments, the anti-foaming agent is FOAMSTAR® ST2438.

As used herein, the term “rheology modifier” refers to a compound or composition added into a formula to modify the rheology of the formula. For example, a rheology modifier may effect a rapid but controlled increase in viscosity, with a view to improving the sag resistance of a coating, or to improving the transportability and storage properties of a coating material by preventing the pigment or other solids in the coating material from settling. In some embodiments, an inorganic rheology modifier such as clay, fumed silica, or a special clay (e.g., sepiolite, attapulgite, or green earth) is used. In other embodiments, an organic rheology modifier such as a cellulose-based material or a composite material (e.g., a hydrophobically modified polyurethane, a hydrophobically modified polyether, an alkali swellable emulsion, or a castor oil-based thixotropic agent) is used. In some embodiments, BENTONE® DE, which is a highly synergistic hectorite clay in the form of ultra-dispersed powder, is used as the rheology modifier.

As used herein, the term “filler” or “extender” may be any suitable material, e.g., any dry inert (e.g., chemically inert) material. A filler may be added for various reasons. For example, some embodiments use an added filler to lower cost; to change the strength, weight, or appearance of blanks; or to render a resin coating more suitable for the intended application before or after the coating cures. In some embodiments, the filler used is selected from the group consisting of microspheres (e.g., hollow ceramic microspheres, FILLITE® of Tolsa USA Inc. (a high-strength glass-hard inert silicate in the form of hollow spheres), perlite-derived microspheres (La Pin, France, NOBLITE® of Noble International SA), perlite microspheres, plastic microspheres (e.g., phenolic resin-based, amino-based, or vinyl-based microspheres), expandable microspheres (e.g., those disclosed in U.S. Pat. No. 3,615,972, whose disclosure is incorporated herein by reference), or EXPANCEL™ microspheres of AkzoNobel (USA), calcium carbonate, limestone sand, marble powder, magnesium silicates (e.g., talc, such as talc powder), slate powder, silica (e.g., CAB-O-SIL® or CAB-O-SPERSE® fumed silica of Cabot Corp. (USA), colloidal silica, aluminum hydroxide, alumina, barium sulfate (BaSO₄, such as Blanc Fixe Micro of Sachtleben Chemie (Germany)), metal powder (e.g., brass, copper, aluminum, iron, or bronze), a fiber-based filler, polyethylene fiber (e.g., Poly Fiber II of Polytek® Development Corp.), glass fiber (e.g., frosted glass fiber or short glass fiber), carbon fiber (e.g., milled carbon fiber), walnut shell powder, hickory shell powder, wood powder, corncob powder, rice hull powder, ground rubber, ground leather, cellulose (e.g., cotton fiber, sisal, flax, hemp, or other natural fibers), and a mixture of the above. In some embodiments, the filler or extender used includes talc powder and barium sulfate.

As used herein, the term “corrosion inhibitor” refers to an ingredient (e.g., a chemical or composition) added into a formula to reduce the corrosion rate of the material to which a product of the formula is applied. For example, when a corrosion inhibitor-containing fluid is in contact with a metal surface, the corrosion inhibitor can reduce corrosion of the metal surface. As used herein, the term “anti-rust agent” refers to a corrosion inhibitor that can prevent an iron surface, for example, from corrosion. In some embodiments, the corrosion inhibitor used is selected from inorganic compounds such as a chromate, phosphate, polyphosphate, sulfate, sulfite, molybdate, borate, metaborate, phosphorus silicate, silicate, or phosphite of Na, K, Zn, Ca, Sr, Ba, Al, Mg, Pb, Cr, Fe, or a combination of the aforesaid anion and cation species. In other embodiments, the corrosion inhibitor used is an organic compound such as a thiol or a derivative of dithiocarbonic acid, of dithiocarbamic acid, or of dithiophosphoric acid. Some other examples of organic corrosion inhibitors are N-containing heterocyclic mercapto derivatives (e.g., 2-mercaptobenzothiazole (MBT)), amines (e.g., hexamine, phenylenediamine, dimethylaminoethanol, and derivatives of the above), ascorbic acid, and benzotriazole. In some embodiments, the corrosion inhibitor used is a mixture or the reaction products of the inorganic/organic inhibitors (e.g., Zn(MBT)₂) disclosed in U.S. Pat. No. 6,139,610, whose disclosure is incorporated herein by reference. In some embodiments, the corrosion inhibitor used is zinc phosphate or an organic complex of zinc, such as NALXIN® FA 579 of Elementis plc (USA).

As used herein, the term “dispersant” or “dispersing agent” refers to a surface-active or non-surface-active compound that is added into a suspension (e.g., a colloid) to enhance particle separation and prevent settling, agglomeration, flocking, and clumping. The dispersing agent to be added into a formula is determined by the formula and may be a compound capable of providing particle space stabilization or electrostatic stabilization in the formula. In some embodiments, for example, the dispersing agent used may be a non-ionic, anionic, or cationic surface-active polymer or surfactant, such as a quaternary ammonium salt or alkyl polyamine (cationic), polyacrylic acid or a sulfonated organic substance (anionic), or a non-ionic or substantially non-ionic substance with a hydrophilic group (e.g., an ethylene oxide or propylene oxide unit). In some embodiments, the dispersing agent used is polyacrylic acid, such as DISPEX® CX 4320 of BASF (Germany).

As used herein, the term “curing” refers to the toughening or hardening of a polymer material by way of the cross-linking of polymer chains, which may be induced by an electron beam, ultraviolet (UV) radiation, heat, a chemical additive, or a combination of the above. As used herein, the term “curing agent” refers to a chemical compound or composition that is added into a resin composition to toughen or harden the composition (e.g., when the composition is applied to a surface). In some embodiments, the curing agent used is one or more selected from the group consisting of an aliphatic amine, an aromatic amine, a tertiary amine, a primary amine, a polyamine, a polyamine epoxy resin adduct, a ketimine, a polyamide resin, an imidazole, a polythiol, a polysulfide resin, an aromatic anhydride, an alicyclic anhydride, an aliphatic anhydride, a latent curing agent, and a UV/photocuring agent. Some embodiments of the formulas disclosed herein may use a curing agent compound selected from the group consisting of the following without limitation: a diphenyliodonium hexafluorophosphate, a triphenylsulfonium hexafluorophosphate, diethylenetriamine, triethylenetetramine, tetraethylenepentamine, dipropylenediamine, 3-diethylaminopropylamine, hexamethylenediamine, N-aminoethylpiperazine, menthanediamine, isophoronediamine, m-xylenediamine, m-phenylene diamine, diaminodiphenylmethane, diaminodiphenyl sulfone, piperidine, N,N-dimethylpiperidine, triethylenediamine, 2,4,6-tris(dimethylaminomethyl)phenol, benzyldimethylamine, 2-(dimethylaminomethyl)phenol, 2-methylimidazole, 2-ethyl-4-methylimidazole, 1-cyanoethyl-2-undecylimidazole trimellitate, phthalic anhydride, trimellitic anhydride, pyromellitic dianhydride, benzophenonetetracarboxylic dianhydride, ethylene glycol bis(4-trimellitate anhydride), glycerol tris(trimellitate anhydride), maleic anhydride, tetrahydrophthalic anhydride, methyl tetrahydrophthalic anhydride, endomethylene tetrahydrophthalic anhydride, methyl endomethylene tetrahydrophthalic anhydride, methylbutenyl tetrahydrophthalic anhydride, dodecenyl succinic anhydride, hexahydrophthalic anhydride, hexahydro-4-methylphthalic anhydride, succinic anhydride, methyl cyclohexene-dicarboxylic anhydride, styrene-maleic anhydride copolymer, chloroacetic anhydride, poly(azelaic anhydride), a BF₃-amine complex, organic-acid hydrazide, and dicyandiamide. In one preferred embodiment, the curing agent used is a polyamine adduct, such as EPIKURE™ curing agent 8530-W-75 of Hexion Inc. (Columbus, Ohio, USA). In one preferred embodiment, the coating composition of the present invention is added with an alkaline curing agent, such as an aliphatic polyamine, a cycloaliphatic polyamine, a Mannich base, an amine-epoxy addition product, a polyamide-polyamine, or a liquid aromatic polyamine; some examples of such curing agents are JOINTMINE #4160 and EPIKURE curing agent 8530-W-75 of Hexion. The coating composition of the invention can be applied to a substrate by spray coating, brush coating, curtain coating, air knife coating, or other coating forming techniques, and the resulting coating has outstanding corrosion resistance and water resistance when cured and dry.

The coating composition of the present invention has a solid content, i.e., the percentage of the solids left from the composition after the composition is dried to constant weight. In one preferred embodiment, the coating composition has a solid content ranging from 50% to 60%, such as, but not limited to, 50%, 50.5%, 51%, 51.5%, 52%, 52.5%, 53%, 53.5%, 54%, 54.5%, 55%, 55.5%, 56%, 56.5%, 57%, 57.5%, 58%, 58.5%, 59%, 59.5% or 60%. In a more preferred embodiment, the coating composition has a solid content ranging from 55% to 60%, such as, but not limited to, 55%, 55.1%, 55.2%, 55.3%, 55.4%, 55.5%, 55.6%, 55.7%, 55.8%, 55.9%, 56%, 56.1%, 56.2%, 56.3%, 56.4%, 56.5%, 56.6%, 56.7%, 56.8%, 56.9%, 57%, 57.1%, 57.2%, 57.3% 57.4%, 57.5%, 57.6%, 57.7%, 57.8%, 57.9%, 58%, 58.1%, 58.2%, 58.3%, 58.4%, 58.5%, 58.6%, 58.7%, 58.8%, 58.9%, 59%, 59.1%, 59.2%, 59.3%, 59.4%, 59.5%, 59.6%, 59.7%, 59.8%, 59.9% or 60%.

The coating composition of the present invention has a viscosity. In one preferred embodiment, the viscosity ranges from about 130 cps/25° C. to about 18000 cps/25° C., such as, but not limited to, about 130 cps/25° C. to about 1000 cps/25° C., about 130 cps/25° C. to about 5000 cps/25° C., about 130 cps/25° C. to about 10000 cps/25° C., about 130 cps/25° C. to about 15000 cps/25° C., about 130 cps/25° C. to about 18000 cps/25° C., about 500 cps/25° C. to about 1000 cps/25° C., about 500 cps/25° C. to about 5000 cps/25° C., about 500 cps/25° C. to about 10000 cps/25° C., about 500 cps/25° C. to about 15000 cps/25° C., about 500 cps/25° C. to about 18000 cps/25° C., about 3000 cps/25° C. to about 5000 cps/25° C., about 3000 cps/25° C. to about 7000 cps/25° C., about 3000 cps/25° C. to about 10000 cps/25° C., about 3000 cps/25° C. to about 15000 cps/25° C., about 3000 cps/25° C. to about 18000 cps/25° C., about 10000 cps/25° C. to about 15000 cps/25° C., about 10000 cps/25° C. to about 18000 cps/25° C. or about 12000 cps/25° C. to about 18000 cps/25° C. and so on. In one preferred embodiment, the viscosity ranges from about 4000 cps/25° C. to about 17000 cps/25° C., such as, but not limited to, about 4000 cps/25° C. to about 7000 cps/25° C., 4000 cps/25° C. to about 10000 cps/25° C., 4000 cps/25° C. to about 13000 cps/25° C., 4000 cps/25° C. to about 17000 cps/25° C., 7000 cps/25° C. to about 10000 cps/25° C., 7000 cps/25° C. to about 14000 cps/25° C., 7000 cps/25° C. to about 17000 cps/25° C., 9000 cps/25° C. to about 10000 cps/25° C., 9000 cps/25° C. to about 14000 cps/25° C., 9000 cps/25° C. to about 17000 cps/25° C. or 10000 cps/25° C. to about 17000 cps/25° C. and so on. In another preferred embodiment, the viscosity is greater than 600 cps/25° C.

As used herein, the term “water-soluble solvent” refers to any solvent that is inactive to the ingredients of the present invention. Some examples of water-soluble solvents are esters, alcohols, glycol dimethyl ether, propylene glycol monomethyl ether, dipropylene glycol tertiary-butyl ether, and ketones. In some embodiments, the water used may include deionized water and/or distilled water. In some embodiments, the solvent used is selected from the group consisting of propylene glycol methyl ether (PGME), methanol, ethanol, a glycol ether (e.g., diethyl ether, tertiary-butyl ether, or a cyclic ether), a diol, a ketone (e.g., acetone), and a mixture of the above. In some embodiments, the water-borne epoxy resin barely contains any volatile organic solvent such as an aliphatic hydrocarbon-based, ethyl acetate-based, glycol ether-based, or acetone-based solvent (e.g., with a volatile organic solvent content less than 1000 ppm, 100 ppm, 10 ppm, or 1 ppm).

As used herein in association with the application tests of the present invention, the term “hardness” refers to a measure of the resistance against localized plastic deformation caused by mechanical indentation or abrasion. Hardness can be measured by different methods, depending on the material to be tested. For example, the Mohs scale is a scale with reference to the ability of a natural mineral sample to make a noticeable scratch on another mineral sample. Generally, the hardness of a polymer (e.g., rubber or plastic) is expressed as a Shore hardness value and is measured with a Shore durometer, which measures the depth of the indentation left in the material on a standardized presser foot by a given force. Another hardness scale is based on ASTM test method D3363-00 (Standard Test Method for Film Hardness by Pencil Test), in which pencils are used to scratch the surface of the film under test in order to identify the hardness of the film as 9B, 8B, 7B, 6B, 5B, 4B, 3B, 2B, B, HB, F, H, 2H, 3H, 4H, 5H, 6H, 7H, 8H, or 9H (which grades correspond to the hardness of the lead or graphite cores of the pencils and are sequentially arranged from the softest, i.e., 9B, to the hardest, i.e., 9H). More specifically, the ASTM test method is performed by placing the sample to be tested (e.g., a test panel that has been coated) on a sturdy horizontal surface; holding a pencil (whose hardness has been calibrated as any one of 9B to 9H) in such a way that the tip of the pencil stays firmly pressed at a test point on the film, and that the pencil and the film form an included angle of 45°; and pushing the pencil away from the operator in a 6.5-mm (¼-in.) stroke. The test procedure starts with the hardest pencil and continues with increasingly softer pencils until the pencil being used cannot cut into or score the film. The hardness of the film is then determined as the hardness of the hardest pencil that fails to scratch the sample surface. In some embodiments, the coating composition of the invention can form a coating whose hardness is higher than 9B (e.g., higher than 8B, higher than 7B, higher than 6B, higher than 5B, higher than 4B, higher than 3B, higher than 2B, or higher than B).

As used herein, the term “adhesion” refers to the attractive force with which two different substances are connected to each other. For example, the adhesion of a resin coating refers to the minimum force required to make a layer of the resin coating material completely attached to a substrate, such as a metal substrate. A relatively durable coating that is relatively resistant to chemical corrosion has relatively high coating adhesion. Adhesion can be quantified using ASTM test methods D3359-09, which grade adhesion on a 0 to 5 scale, with grade 0 indicating the lowest adhesion and grade 5 indicating the highest adhesion. The ASTM test methods are carried out by making a cut in the film/coating on a metal substrate and then applying and removing pressure-sensitive tape to and from the cut in order to evaluate the adhesion between the coating and the metal substrate. The test methods include test method A and test method B. In test method A, an X-shaped cut is made through the film to the substrate, and pressure-sensitive tape is applied over and then removed from the cut in order to assess the adhesion of the film qualitatively on a 0 to 5 scale. The adhesion grades for test method A are as follows: 5A, indicating no peeling or removal; 4A, indicating trace peeling or removal along the incisions or at their intersection; 3A, indicating jagged removal along the incisions up to 1.6 mm ( 1/16 in.) on either side; 2A, indicating jagged removal along most of the incisions up to 3.2 mm (⅛ in.) on either side; 1A, indicating that most of the area of the X under the tape is removed; and OA, indicating removal beyond the area of the X. In test method B, a lattice pattern with either six or eleven cuts in each direction is made in the film to the substrate, and pressure-sensitive tape is applied over and then removed from the lattice in order to assess the adhesion of the film by comparison with descriptions and illustrations. The adhesion grades for test method B are as follows: 5B, indicating that the edges of the cuts are completely smooth, and that none of the squares of the lattice is detached; 4B, indicating that small flakes of the coating are detached at intersections, and that the affected area is less than 5% of the lattice; 3B, indicating that small flakes of the coating are detached along edges and at intersections of the cuts, and that the affected area is 5% to 15% of the lattice; 2B, indicating that the coating has flaked along the edges and on parts of the squares, and that the affected area is 15% to 35% of the lattice; 1B, indicating that the coating has flaked along the edges of the cuts in large ribbons, that whole squares have detached, and that the affected area is 35% to 65% of the lattice; and 0B, indicating flaking and detachment worse than grade 1B. In some embodiments, the present invention gives rise to coating adhesion higher than grade 5B of ASTM D3359-09-test method B.

As used herein, the term “corrosion” refers to the process by which a material is degraded. As far as metal is concerned, corrosion refers to the reaction by which a metal is converted into a more chemically-stable form, such as an oxide, hydroxide, or sulfide. Generally, corrosion involves a gradual damage to the affected material and is so slow (e.g., taking several months or even years) that an accelerated test is typically required for the evaluation of corrosiveness or corrosion resistance. The salt spray or salt fog test is a common corrosion test method for testing the corrosion resistance of a material or a surface coating. In most cases, the material to be tested is the coating on a metal surface (although a stone, ceramic, or polymer surface is equally feasible), wherein the coating is intended to provide a certain degree of corrosion protection for the metal below. The salt spray test is an accelerated corrosion test in which a coated sample is corroded in order to evaluate the (relative) applicability of the coating as a protective coating. More specifically, the appearance of the corrosion product (e.g., rust or other oxides) is evaluated after a predetermined amount of time, and the test duration depends on the corrosion resistance of the coating. Generally, the higher the corrosion resistance of the coating is, the longer the time required for corrosion (e.g., rust) to take place will be. There are several salt spray test standards, the most notable one of which is ASTM test method B117. Other major related standards are ISO 9227, JIS Z 2371, and ASTM G85. The salt spray test is a subjective test depending on the grading system of a particular test operation and test environment (e.g., laboratory). For example, a test may be conducted to assess the number of corrosion points on a test sample, the number of pits in the sample, any loss of the coating material, any change in color of the sample, and/or any change in mass of the sample (e.g., a loss of mass due to a loss of material, or an increase of mass due to oxidation). If it is desired to determine the development of corrosion in a certain corroded area of the coating, the test may further include making a cut through the coating to the substrate, as stated in ASTM test method D1654. The salt spray test, therefore, can be used as a comparative test on the corrosion resistance of different coating compositions. For example, if a first coating has fewer corrosion points, fewer pits, a smaller loss of the coating material, a less noticeable change in color, a smaller change in mass, a smaller number of other signs of corrosion, or a combination of the above than a second coating and a third coating on the same substrate, it can be determined that the first coating is superior to (e.g., better than, more resistant to corrosion than, or less corroded than) the other two coatings on the substrate. Corrosion resistance may be graded as good, normal/fair, or poor. In some embodiments, the coating compositions of the present invention form coatings that are more resistant to corrosion than those lacking one or more ingredients of the invention. In one preferred embodiment, the coating composition of the invention has a loss of mass less than about 0.36 g in the salt spray test (ASTM B117). In a more preferred embodiment, the coating composition of the invention has a loss of mass less than about 0.17 g in the salt spray test (ASTM B117).

The present invention is more detailed illustrated by the example embodiments as below. While example embodiments are disclosed herein, it should be understood that they are used for illustrating the present invention, not for limiting the scope of the present invention.

### Embodiment 1: Synthesis of Compound S1.1 and Preparation of Water-Borne Epoxy Resin Composition S1.2

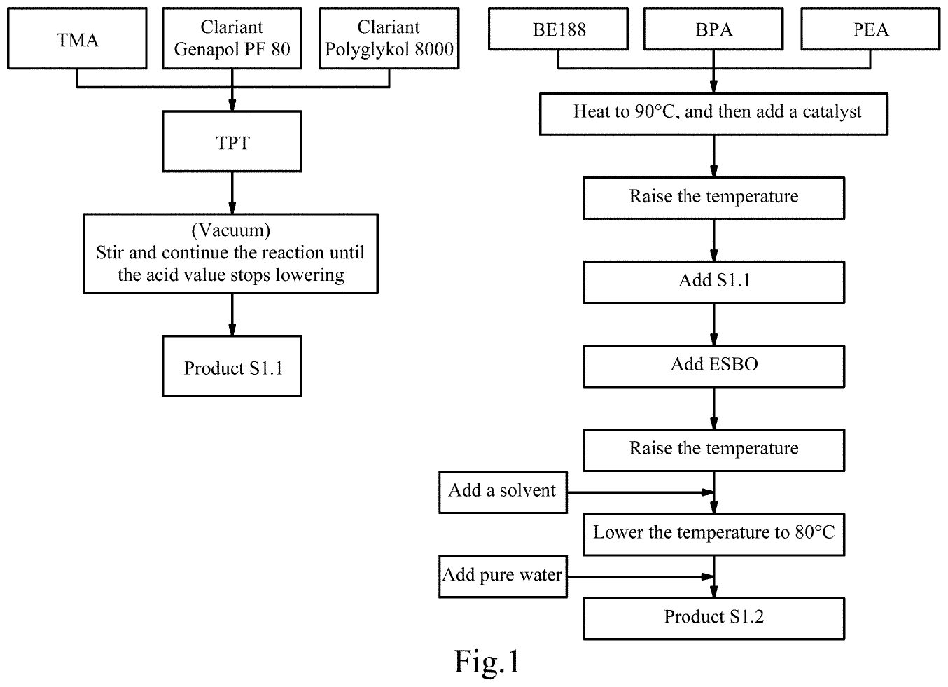

Referring to FIG. 1, trimellitic anhydride (TMA, as represented by the following chemical formula (XI)) was mixed with an EO-PO-EO block copolymer-containing compound (Genapol PF 80 of Clariant, with MW=8000) and a polyethylene glycol (polyglykol 8000 of Clariant, with MW=8000) and reacted with titanium (IV) isopropoxide (TPT) serving as a catalyst. The mixture was stirred in vacuum and allowed to react until its acid value stopped lowering. The reaction product was compound S1.1, which had the structure of the aforesaid chemical formula (II).

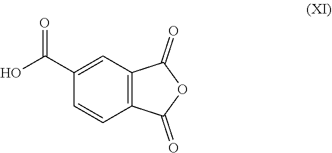 [SMILES: O=C(O)c1ccc2c(c1)C(=O)OC2=O]

A bisphenol A diglycidyl ether (BE188, Chang Chun Group) was mixed with BPA and polyetheramine (PEA) (JEFFAMINE® M-2070, Huntsman Corporation). The mixture was stirred, heated to about 90° C., and then added with a catalyst. The temperature of the mixture was further raised in order for a reaction to take place, and compound S1.1 was subsequently added as an emulsifier, followed by an epoxidized oil (e.g., epoxidized soybean oil (ESBO)). After that, the temperature of the mixture was raised again for reaction, before the addition of an alcohol-ether solvent (e.g., propylene glycol monomethyl ether). The temperature of the mixture was then lowered to 80° C., and pure water was added into the mixture to obtain water-borne epoxy resin composition S1.2.

### Embodiment 2: Synthesis of Compound S2.1 and Preparation of Water-Borne Epoxy Resin Composition S2.2

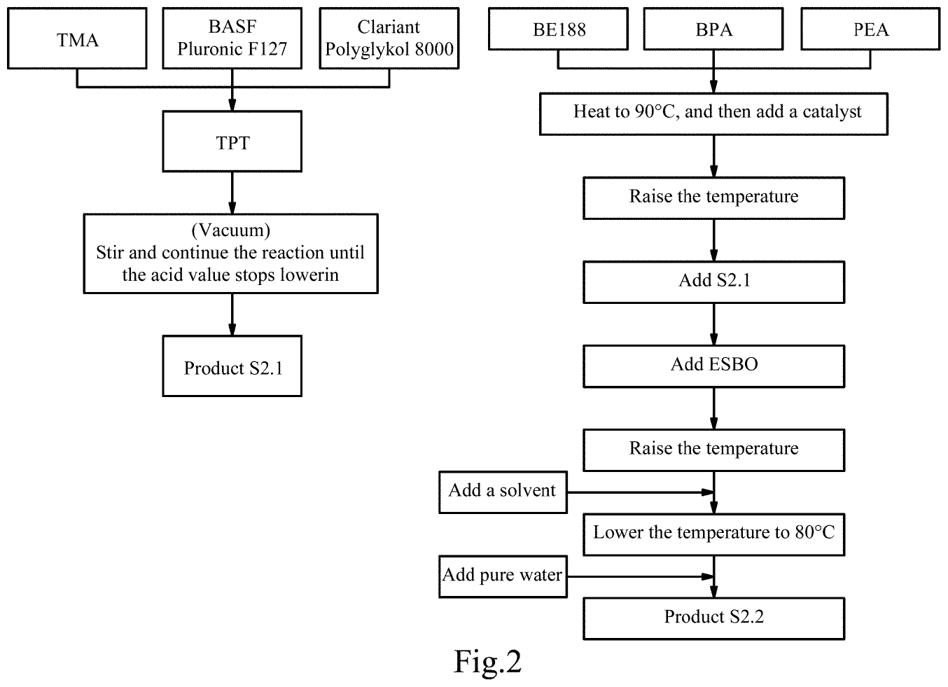

Referring to FIG. 2, the ingredients and method used in embodiment 1 to synthesize compound S1.1 were used to synthesize compound S2.1, the only difference being that the starting ingredients included an alternative EO-PO-EO block copolymer-containing compound (Pluronic F127 of BASF, with MW=12500) to increase the molecular weight of the synthesized product, namely compound S2.1, which had the structure of the aforesaid chemical formula (TI).

Then, the ingredients and method used in embodiment 1 to prepare water-borne epoxy resin composition S1.2 were used to prepare water-borne epoxy resin composition S2.2, the only difference being that compound S2.1 was added in place of compound S1.1 as the emulsifier. The reaction product was water-borne epoxy resin composition S2.2.

### Embodiment 3: Synthesis of Compound S3.1 and Preparation of Water-Borne Epoxy Resin Composition S3.2

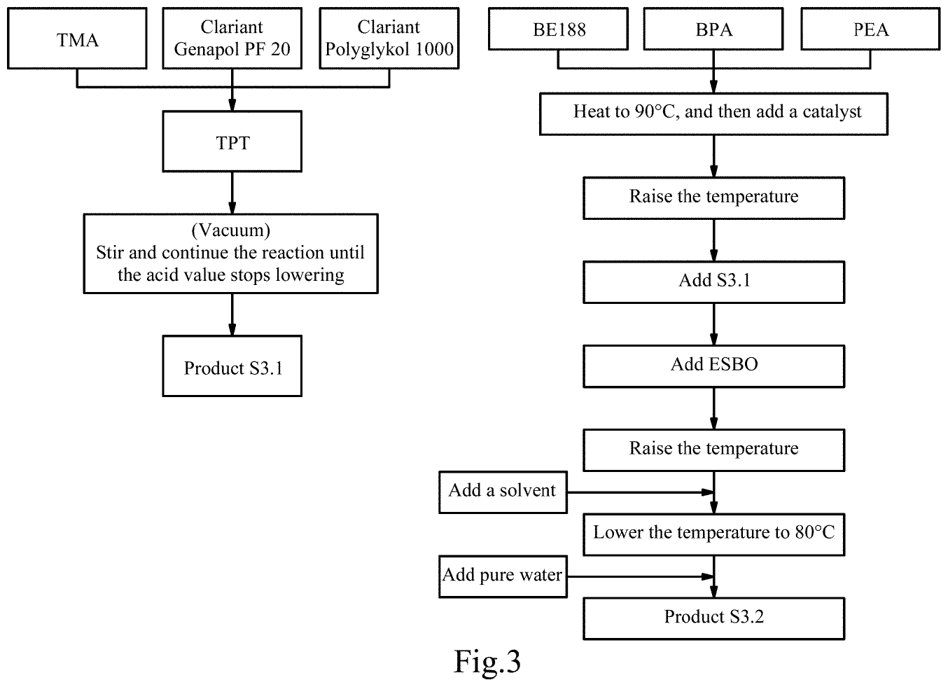

Referring to FIG. 3, the ingredients and method used in embodiment 1 to synthesize compound S1.1 were used to synthesize compound S3.1, the only difference being that the starting ingredients included an alternative EO-PO-EO block copolymer-containing compound (Genapol PF 20 of Clariant, with MW=2500) and an alternative polyethylene glycol with a different molecular weight (polyglykol 1000 of Clariant, with MW=1000) to reduce the molecular weight of the synthesized product, namely compound S3.1, which had the structure of the aforesaid chemical formula (I).

Then, the ingredients and method used in embodiment 1 to prepare water-borne epoxy resin composition S1.2 were used to prepare water-borne epoxy resin composition S3.2, the only difference being that compound S3.1 was added in place of compound S1.1 as the emulsifier. The reaction product was water-borne epoxy resin composition S3.2.

### Embodiment 4: Synthesis of Compound S4.1 and Preparation of Water-Borne Epoxy Resin Composition S4.2

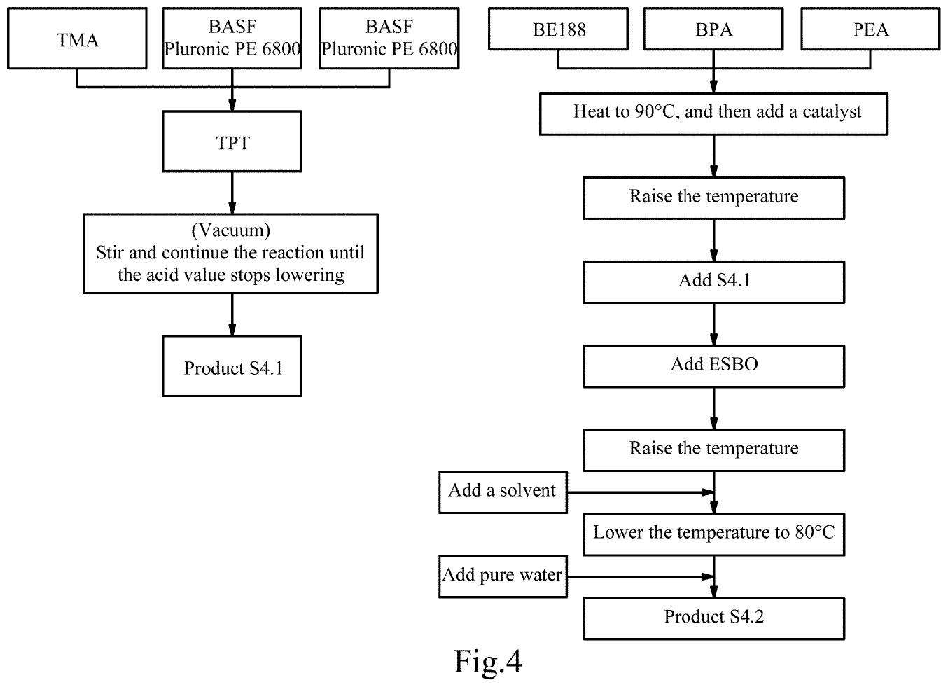

Referring to FIG. 4, the ingredients and method used in embodiment 1 to synthesize compound S1.1 were used to synthesize compound S4.1, the only difference being that the starting ingredients included an alternative EO-PO-EO block copolymer-containing compound (Pluronic PE 6800 of BASF, with MW=8000) and dispensed with the polyethylene glycol. The synthesized product, namely compound S4.1, had the structure of the aforesaid chemical formula (V).

Then, the ingredients and method used in embodiment 1 to prepare water-borne epoxy resin composition 51.2 were used to prepare water-borne epoxy resin composition S4.2, the only difference being that compound S4.1 was added in place of compound S1.1 as the emulsifier. The reaction product was water-borne epoxy resin composition S4.2.

### Embodiment 5: Synthesis of Compound S5.1 and Preparation of Water-Borne Epoxy Resin Composition S5.2

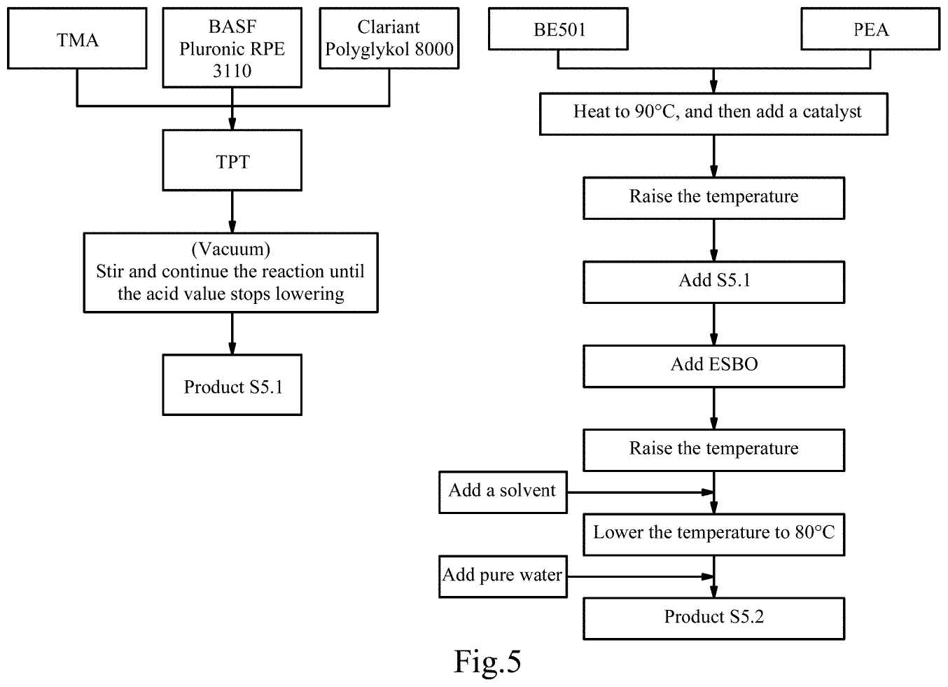

Referring to FIG. 5, the ingredients and method used in embodiment 1 to synthesize compound S1.1 were used to synthesize compound S5.1, the only difference being that the starting ingredients included a PO-EO-PO block copolymer-containing compound (Pluronic RPE 3110 of BASF, with MW=3500) instead of the EO-PO-EO block copolymer-containing compound. The synthesized product, namely compound 55.1, had the structure of the aforesaid chemical formula (VI).

Then, the ingredients and method used in embodiment 1 to prepare water-borne epoxy resin composition S1.2 were used to prepare water-borne epoxy resin composition S5.2, the only differences being that the bisphenol A diglycidyl ether (BE188) and the BPA were directly replaced by a BPA epoxy resin (BE501 of Chang Chun Group), and that compound S5.1 was added in place of compound S1.1 as the emulsifier. More specifically, the BPA epoxy resin (BE501) was mixed with the PEA, and the mixture was stirred, heated to about 90° C., and then added with the catalyst. The temperature of the mixture was further raised in order for a reaction to take place, and compound S5.1 was subsequently added as the emulsifier, followed by the epoxidized soybean oil. After that, the temperature of the mixture was raised again for reaction, before the addition of the propylene glycol monomethyl ether. The temperature of the mixture was then lowered to 80° C., and pure water was added into the mixture to obtain water-borne epoxy resin composition S5.2.

### Embodiment 6: Synthesis of Compound S6.1 and Preparation of Water-Borne Epoxy Resin Composition S6.2

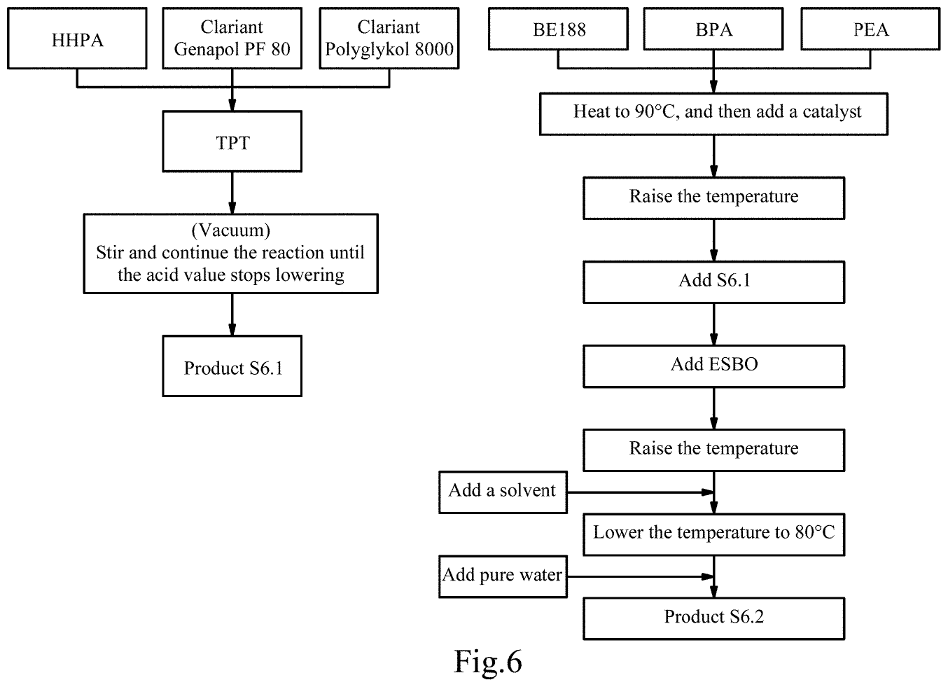

Referring to FIG. 6, the ingredients and method used in embodiment 1 to synthesize compound S1.1 were used to synthesize compound S6.1, the only difference being that the starting ingredients included an alternative acid anhydride for reaction. More specifically, hexahydrophthalic anhydride (HHPA, as represented by the following chemical formula (XII)) was used instead of the TMA while the other ingredients and the synthesis method remained the same. The synthesized product, namely compound S6.1, had the structure of the aforesaid chemical formula (VII).

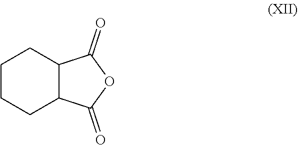 [SMILES: O=C1OC(=O)C2CCCCC12]

Then, the ingredients and method used in embodiment 1 to prepare water-borne epoxy resin composition S1.2 were used to prepare water-borne epoxy resin composition S6.2, the only difference being that compound S6.1 was added in place of compound S1.1 as the emulsifier. The reaction product was water-borne epoxy resin composition S6.2.

### Comparison Example: Synthesis of Compound C1.1 and Preparation of Water-Borne Epoxy Resin Composition C1.2

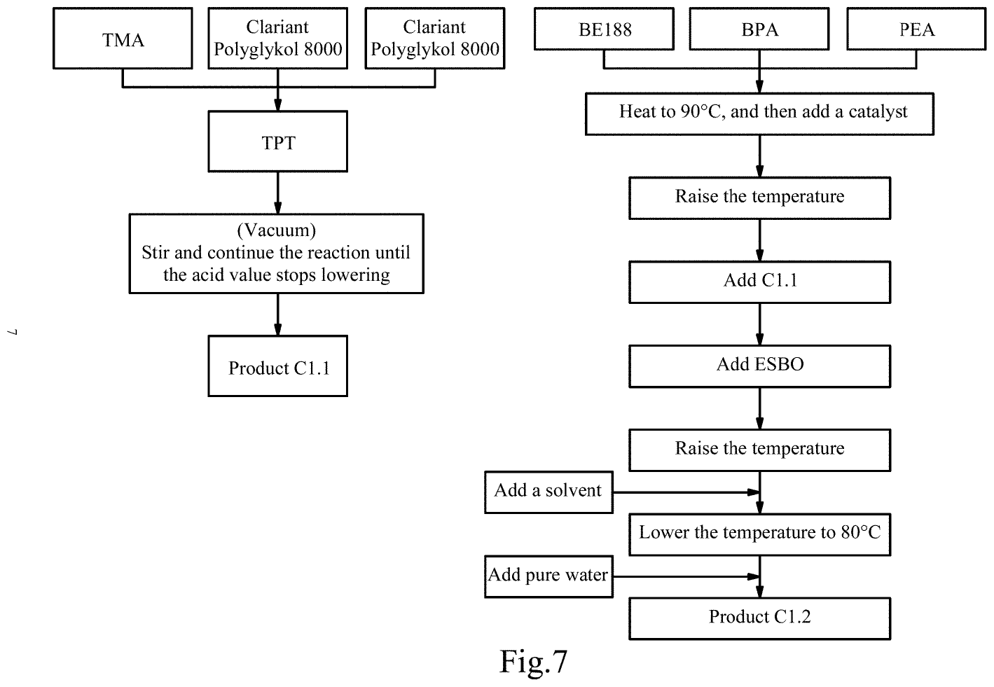

Referring to FIG. 7, the ingredients and method used in embodiment 1 to synthesize compound S1.1 were used to synthesize compound C1.1, the only difference being that the starting ingredients excluded the EO/PO block copolymer-containing compound while the EO block copolymer-containing compound and the other ingredients as well as the synthesis method remained the same. More specifically, the TMA was mixed with the EO block copolymer-containing polyethylene glycol (polyglykol 8000 of Clariant, with MW=8000) and reacted with the TPT serving as the catalyst. The mixture was stirred in vacuum and allowed to react until its acid value stopped lowering. The reaction product was compound C1.1.

Then, the ingredients and method used in embodiment 1 to prepare water-borne epoxy resin composition S1.2 were used to prepare water-borne epoxy resin composition C1.2, the only difference being that compound C1.1 was added in place of compound S1.1 as the emulsifier. The reaction product was water-borne epoxy resin composition C1.2.

### Embodiment 7: Coating Compositions

The water-borne epoxy resin compositions obtained from embodiments 1-6 and the comparison example (i.e., S1.2 to S6.2 and C1.2) were used to prepare coating compositions. TABLE 1 lists the ingredients of the coating compositions and divides the ingredients into part A and part B. The coating compositions prepared in this embodiment were intended for use as white paint, and the preparation method is as follows.

Preparation of a white color paste: The dispersing agent, the anti-foaming agent, and the anti-flash rust agent were added into the deionized water in amounts specified in the formula, in order to disperse the aforesaid additives in the water in advance. All the remaining powdery ingredients (except for the rheology modifier Bentone DE) were weighed and then added in three additions. Each addition was followed by a stirring and dispersing operation that ended only when viscosity was lowered and lumps of powder disappeared, and the third as well as the second addition was conducted only when the previous stirring and dispersing operation was completed. During the process, water was added when the mixture was too tacky to be stirred. The resulting mixture was added with the beads and ground. The grinding process generated heat such that the temperature of the mixture rose up to 60° C. After grinding for 20 to 30 minutes, 7 g aqueous Bentone DE solution (prepared by dispersing the bentonite in deionized water at a ratio of 14% (bentonite) to 86% (water)) was added into the mixture, which was then stirred at low speed until homogenized and was subsequently sieved to produce a white color paste.

Addition of the water-borne epoxy resin composition: Each 10 g of color paste was thoroughly mixed with 6 g of water-borne epoxy resin composition S1.2, S2.2, S3.2, S4.2, S5.2, S6.2, or C1.2 to produce a white paint, i.e., part A of each coating composition.

Addition of the curing agent: Hexion 8530 (N.V.=75%, amine hydrogen equivalent weight (AHEW)=100) was used as the curing agent. The curing agent was first diluted to 80% with polymethacrylate (PMAc) and then added with the specified amount of white paint. The viscosity of each white paint and curing agent mixture was adjusted with PMAc until spray coating was possible. The resulting coating compositions were identified as S1, S2, S3, S4, S5, S6, and C1 respectively.

TABLE 1
Formula of the coating compositions

| | | | |
|---|---|---|---|
| Ingredients | Supplier | Weight (g) | Note |

Part A

| | | | |
|---|---|---|---|
| DI Water | — | 75 | Deionized water |
| TiO₂ R960 | DuPont | 40 | White pigment |
| NALZIN FA 579 | ELEMENTIS | 2 | Anti-rust agent |
| Foamstar ST2438 | BASF | 0.8 | Anti-foaming agent |
| Bentone DE | ELEMENTIS | 0.98 (7*0.14) | Rheology modifier |
| H7000W | TALC | 60 | Talc powder |
| Blanc Fixe Micro+ | SACHTLEBEN | 40 | BaSO₄, functional filler |
| Zinc phosphate | HALOX | 32 | Corrosion inhibitor |
| Dispx CX 4320 | BASF | 4 | Dispersing agent |

Disperse at high speed to 5~6 Hegman. Lower speed and add:

| | | | |
|---|---|---|---|
| Water-borne epoxy | CCPK | 160 | Water-borne epoxy resin |
| resin composition | | | composition S1.2, S2.2, S3.2, |
| | | | S4.2, S5.2, S6.2, or C1.2 |
| | | | N.V. = 54%, WPE = 620 |

Part B

| | | | |
|---|---|---|---|
| EPIKURE curing agent | Hexion | 14.86 | Curing agent |
| 8530-W-75 | | | N.V. = 75%, AHEW = 100 |

The embodiments and the comparison example were designed to achieve a solid content of 55%˜56% and an epoxide equivalent of 600˜620 g/eq. A comparison of the physical properties of the coating compositions in the embodiments and the comparison example is shown in TABLE 2.

TABLE 2

| | | | | | | | Comparison |
|---|---|---|---|---|---|---|---|
| | Embodiment | | | | | | example |
| | S1 | S2 | S3 | S4 | S5 | S6 | C1 |
| Compound | TMA | TMA | TMA | TMA | TMA | HHPA | TMA |
| formula | Genapol | Pluronic | Genapol | Pluronic | Pluronic | Genapol | polyglykol |
| | PF 80 | F127 | PF 20 | PE6800 | RPE 3110 | PF 80 | 8000 |
| | polyglykol | polyglykol | polyglykol | Pluronic | polyglykol | polyglykol | polyglykol |
| | 8000 | 8000 | 1000 | PE6800 | 8000 | 8000 | 8000 |
| Solid content (%) | 55.1 | 55.8 | 55.0 | 55.6 | 55.2 | 55.1 | 54.9 |
| Viscosity (cps/25° C.) | 4425 | 13230 | 158 | 16750 | 9772 | 600 | 3860 |
| Epoxide equivalent | 607 | 613 | 615 | 611 | 610 | 609 | 617 |
| (g/eq.) | | | | | | | |

Test 1: Rapid Drying Test

Samples were prepared by applying each of coating compositions S1, S2, S3, S4, S5, S6, and C1 to a number of substrates. The samples were allowed to cure at 60° C. for 30 minutes, before the coating adhesion test and the hardness test were performed. ASTM D3363-00 (Standard Test Method for Film Hardness by Pencil Test) was used to determine the hardness of the coating formed by each coating composition. Based on ASTM D3359-09, the cross hatch adhesion of the sample films was of at least grade 5B. It is worth noting that, according to the data in TABLE 3, the S1, S2, S4, and S5 coatings were harder than the C1 coating.

TABLE 3
Rapid drying test results (ASTM D3359-09 and D3363-00)

| Coating | Adhesion | Hardness by pencil test |
|---|---|---|
| composition | (ASTM D3359-09) | (ASTM D3363-00) |
| S1 | 5B | HB |
| S2 | 5B | HB |
| S3 | 5B | B |
| S4 | 5B | HB |
| S5 | 5B | HB |
| S6 | 5B | B |
| C1 | 5B | B |

Test 2: Corrosion Test

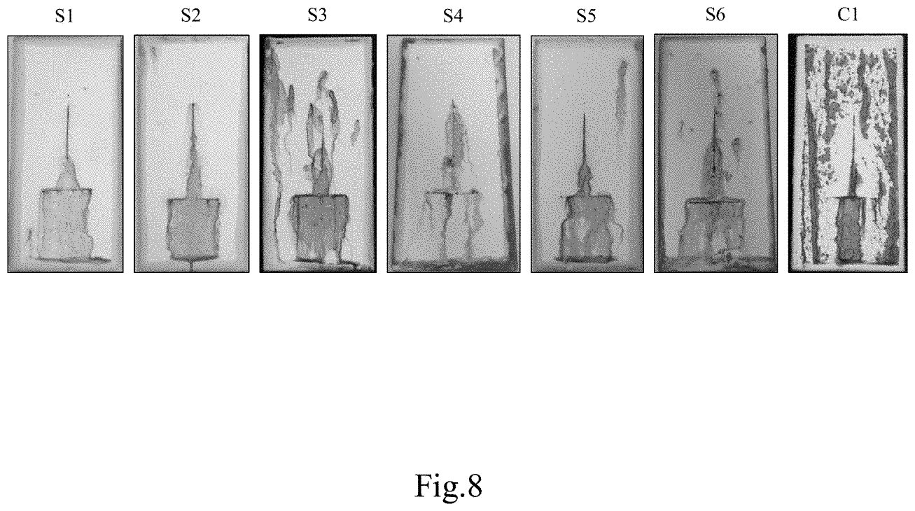

Samples were prepared by applying each of coating compositions S1, S2, S3, S4, S5, S6, and C1 to three substrates. Each sample was tested by ASTM test method B117 and exposed to salt fog for 250 hours. The average values of the three test results of each coating composition were graded as good, fair, or poor in TABLE 4, alongside the quantitative assessment result of weight loss. According to the test results, sample C1 of the comparison example lost more weight (as much as 0.367 g) to corrosion than samples S1 to S6 of the embodiments. FIG. 8 shows more test results of samples S1, S2, S3, S4, S5, S6, and C1 (from left to right), or more particularly the evaluation results as to whether corrosion spread out from the incisions and whether the coating surface rusted, peeled off, or had bubble points, pinholes, or cracks. According to the test results in FIG. 8, the samples coated respectively with S1, S2, S3, S4, S5, and S6 exhibited higher resistance to corrosion than those coated with C1.

TABLE 4
Corrosion test results

| Coating | Corrosion | Weight |
|---|---|---|
| composition | resistance | loss (g) |
| S1 | Good | 0.102 |
| S2 | Good | 0.110 |
| S3 | Fair | 0.189 |
| S4 | Good | 0.124 |
| S5 | Good | 0.132 |
| S6 | Fair | 0.172 |
| C1 | Poor | 0.367 |

As above, one objective of the present invention is to provide a novel compound that functions as a surfactant and can be added to an epoxy resin composition as an emulsifier to enhance the compatibility of the epoxy resin in the composition with water and thereby increase the water solubility of the epoxy resin composition containing the compound. The invention further provides a water-borne epoxy resin composition that uses water as its solvent, and a coating composition containing the water-borne epoxy resin composition, wherein both compositions have a much lower volatile organic compound (VOC) content than their prior art counterparts. A coating made of the water-borne epoxy resin composition has not only a low VOC content, but also improved surface properties such as high hardness, high adhesion, and high resistance to corrosion. Furthermore, the molecular weight of the compound disclosed herein for use as an emulsifier in the water-borne epoxy resin composition and the coating composition may vary in order to adjust the viscosity of those compositions and thereby meet the requirements of their respective applications.

The above is the detailed description of the present invention. However, the above is merely the preferred embodiment of the present invention and cannot be the limitation to the implement scope of the present invention, which means the variation and modification according to the present invention may still fall into the scope of the invention.

What is claimed is:

1. A compound of chemical formula (I): 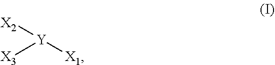
wherein:
Y represents an alicyclic or aromatic group;
X₁ represents 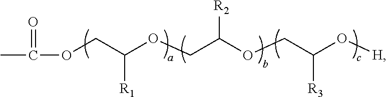
in which at least one or at most two of R₁, R₂, and R₃ are C₁˜C₄ alkyl groups while the remaining ones or one of R₁, R₂, and R₃ is H;
at least one of X₂ and X₃ is —COOH or 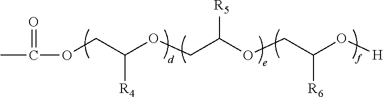
while the remaining one, if any, of X₂ and X₃ is H, wherein each of R₄, R₅, and R₆ is H or a C₁˜C₄ alkyl group; and
each of a, b, c, d, e, and f represents the number of a repeating unit marked thereby and is an integer ranging from 1 to 150.

2. The compound of claim 1, wherein the compound has a structure of at least one selected from the group consisting of chemical formulas (I)˜(VII): 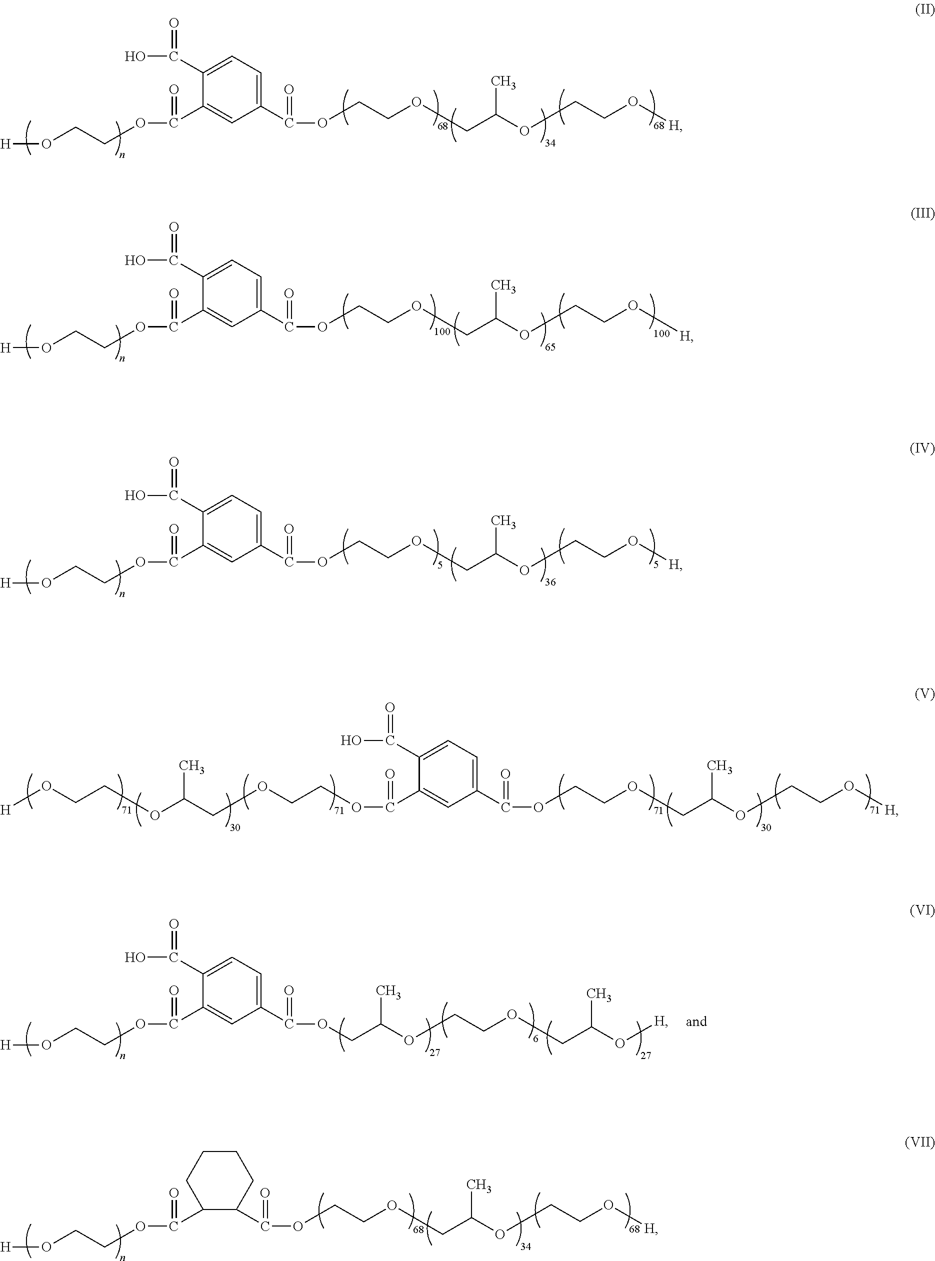
where each n independently represents the number of the repeating units marked thereby and is an integer ranging from 5 to 250.

3. The compound of claim 1, wherein Y is at least one selected from the group consisting of phthalic acid anhydride, trimellitic acid anhydride, pyromellitic acid anhydride, benzophenone-tetracarboxylic acid anhydride, ethylene glycol bis-trimellitate acid anhydride, glycerol tris-mellitate, maleic anhydride, tetrahydrophthalic acid anhydride, methyltetrahydrophthalic acid anhydride, endomethylenetetrahydrophthalic acid anhydride, methylendometylenetetrahydrophthalic acid anhydride, methylbutenyltetrahydrophthalic acid anhydride, dodecenylsuccinic acid anhydride, hexahydrophthalic acid anhydride, methylhexahydrophthalic acid anhydride, succinic acid anhydride, methylcyclohexene-dicarboxylic acid anhydride, alkylstyrene-maleic anhydride copolymers, chlorendic acid anhydride, tetrabromophthalic acid anhydride, polyazelaic acid anhydride, fumaric acid anhydride, itaconic acid anhydride, acrylic acid anhydride, and methacrylic acid anhydride.

4. A water-borne epoxy resin composition, comprising:
(a) an epoxy resin; and
(b) the compound of claim 1.

5. The water-borne epoxy resin composition of claim 4, wherein (b) has a structure of at least one selected from the group consisting of chemical formulas (II)˜(VII): 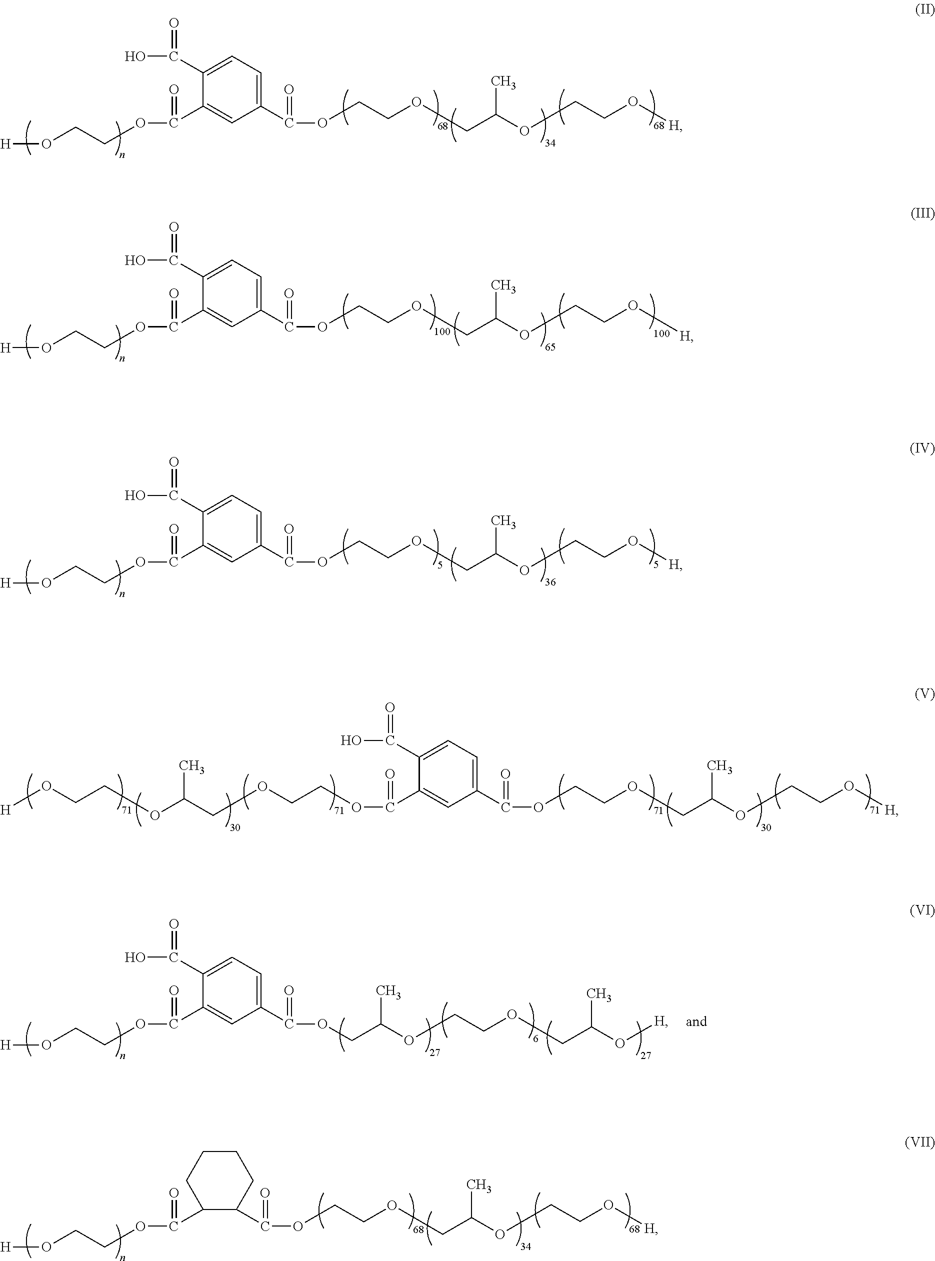
where each n independently represents the number of the repeating units marked thereby and is an integer ranging from 5 to 250.

6. The water-borne epoxy resin composition of claim 4, wherein the (b)/(a) ratio ranges from 5% to 15%.

7. The water-borne epoxy resin composition of claim 4, wherein the epoxide equivalent of the epoxy resin is 150˜3500.

8. The water-borne epoxy resin composition of claim 7, wherein the epoxide equivalent of the epoxy resin is 150˜650.

9. The water-borne epoxy resin composition of claim 8, wherein the epoxide equivalent of the epoxy resin is 500˜650.

10. A coating composition, comprising the water-borne epoxy resin composition of claim 4 dispersed in a solvent.

11. The coating composition of claim 10, wherein the coating composition further includes an additive, which is selected from the group consisting of a pigment, a dye, an anti-foaming agent, an anti-flash rust agent, a rheology modifier, a filler, an extender, a corrosion inhibitor, a dispersing agent, and a combination of the above.

12. The coating composition of claim 10, wherein the coating composition further includes a curing agent.

13. The coating composition of claim 10, wherein the coating composition has a solid content ranging from 50% to 60%.

14. The coating composition of claim 10, wherein the coating composition has a viscosity ranging from about 130 cps/25° C. to about 18000 cps/25° C.

15. The coating composition of claim 10, wherein the coating composition has a viscosity ranging from about 4000 cps/25° C. to about 17000 cps/25° C.

16. The coating composition of claim 10, wherein the coating composition has a viscosity greater than 600 cps/25° C.

17. The coating composition of claim 10, wherein the coating composition has grade B or higher hardness when tested according to ASTM D3363-00 Standard Test Method for Film Hardness by Pencil Test.

18. The coating composition of claim 10, wherein the coating composition has grade 5B adhesion when tested according to ASTM D3359-09 Standard Test Methods for Measuring Adhesion by Tape Test.

19. The coating composition of claim 10, wherein the coating composition has a loss of mass less than about 0.36 g in the salt spray test (ASTM B117).

20. The coating composition of claim 10, wherein the coating composition has a loss of mass less than about 0.17 g in the salt spray test (ASTM B117).
